(19) United States
(12) Patent Application Publication
(10) Pub. No.: US 2008/0095057 A1
(43) Pub. Date: Apr. 24, 2008

(54) METHOD FOR GUARANTEEING QUALITY OF SERVICE FOR USER IN WIRELESS COMMUNICATION SYSTEM

(76) Inventor: Yan ZHOU, Shenzhen (CN)

Correspondence Address: LADAS & PARRY LLP, 224 SOUTH MICHIGAN AVENUE, SUITE 1600, CHICAGO, IL, 60604, US

(21) Appl. No.: 11/962,400

(22) Filed: Dec. 21, 2007

Related U.S. Application Data
(63) Continuation of application No. PCT/CN2006/001435, filed on Jun. 23, 2006.

(30) Foreign Application Priority Data
Jun. 24, 2005 (CN) 200510077749.7

(51) Int. Cl. H04L 12/26

(52) U.S. Cl. 370/235

(57) ABSTRACT

The present invention discloses a method for guaranteeing Quality of Service (QoS) for a user in a wireless communication system, including: setting priority parameter information for the user of the wireless communication system; acquiring, by a QoS control entity, the priority parameter information of the user; and providing a corresponding QoS guarantee for the user dependent upon the priority parameter information of the user. The invention provides respective priority parameter information for respective users in the wireless communication system, and provides differentiated services for the respective users according to their priority parameter information, therefore, in the invention, provision of the differentiated services for the different users may be embodied in a wideband wireless access system of WiMAX or the like, and more abundant operating service modes may be provided by network Operators.

### CROSS-REFERENCE TO RELATED APPLICATIONS

The present application is a continuation of PCT Application No. PCT/CN2006/001435, filed on Jun. 23, 2006, which claims the priority of Chinese Patent Application No. 200510077749.7, filed on Jun. 24, 2005. All of these applications are incorporated herein by reference.

### FIELD OF THE INVENTION

The present invention relates to the field of wireless communication technologies and in particular to a method for guaranteeing Quality of Service (QoS) for a user in a wireless communication system.

### BACKGROUND OF THE INVENTION

In existing wireless communication systems, such as a Wideband Code Division Multiple Address (WCDMA) system and a Code Division Multiple Address (CDMA) system, different QoS guarantees are typically provided as required for different users so as to provide QoS in different levels for the users.

With the development of wireless communication technologies, World Interoperability for Microwave Access (WiMAX) technology based on the 802.16 standard addresses the problem of physical layer environments (outdoor radio frequency transmission), as a result, WiMAX products may be applied indoors and outdoors and capable of supporting data access and voice and video services with a relatively strict real-time requirement. As a wireless Metropolitan Area Network technology satisfying “The Last Mile” access, WiMAX technology may satisfy both a fixed wireless wideband access and a low to medium speed portable access. WiMAX systems have also become new wireless wideband access technologies being researched competitively among the wireless communication systems. The WiMAX systems primarily include an Access Service Network (ASN), a Connectivity Service Network (CSN) and a Subscriber Station (SS). Particularly, the ASN provides a WiMAX SS with a set of network functions for a wireless access service, and particularly includes a Base Station (BS) and a network element of an ASN Gateway (ASN GW). One ASN may be shared among a plurality of CSNs. The CSN provides the WiMAX SS with an IP connectivity service including a function of an Authorization, Authentication and Accounting (AAA) server.

QoS guarantees shall also be provided for a user in a WiMAX system as in the WCDMA system and the CDMA system. However, only local information has been defined for an air interface in the existing WiMAX systems, and no end-to-end QoS parameter or flow has been defined in an entire WiMAX access network. In other words, no QoS parameter for WiMAX has been defined at present, and no corresponding processing flow has been provided.

Consequently, it is impossible at present to provide different QoS guarantees for different users in a WiMAX system. In other words, it is impossible to provide the users with QoS in different levels.

### SUMMARY OF THE INVENTION

An embodiment of the invention provides a method for guaranteeing QoS for a user in a wireless communication system, so that the user may be provided with a reliable QoS guarantee in a wideband wireless access network of WiMAX or the like.

A method for guaranteeing QoS for a user in a wireless communication system, includes:
setting priority parameter information for the user of the wireless communication system;
acquiring, by a QoS control entity, the priority parameter information of the user; and
providing a corresponding QoS guarantee for the user according to the priority parameter information of the user.

The priority parameter information of the user is set at an Authorization, Authentication and Accounting (AAA) server or a QoS policy function entity of the wireless communication system.

The acquiring of the priority parameter information of the user includes:
acquiring, by the QoS control entity, the priority parameter information of the user from an authenticator or a QoS policy enforcement entity.

The QoS control entity sends initiatively a request from the authenticator or the QoS policy enforcement entity, and acquires the priority parameter information of the user, when the QoS control entity requires user subscription information; and
the authenticator or the QoS policy enforcement entity sends initiatively the priority parameter information of the user to the QoS control entity upon acquisition of the priority parameter information of the user.

The authenticator or the QoS policy enforcement entity makes requests for QoS parameters from an AAA server or a QoS policy function entity before the priority parameter information of the user is acquired from the authenticator or the QoS policy enforcement entity; and
the AAA server or the QoS policy function entity returns to the authenticator or the QoS policy enforcement entity information on a set of user parameters including the priority parameter information of the user,

Preferably, the authenticator or the QoS policy enforcement entity stores the acquired priority parameter information of the user locally; and
the authenticator or the QoS policy enforcement entity sends the priority parameter information of the user to the QoS control entity when the QoS control entity sends to the authenticator or the QoS policy enforcement entity the request for acquiring a set of user parameters.

More preferably, the authenticator or the QoS policy enforcement entity sends the priority parameter information of the user to the QoS control entity upon acquisition of the priority parameter information of the user.

Resource allocation, admission control, congestion control processing or other QoS mechanisms for a user service are implemented dependent upon the priority parameter information of the user.

The wireless communication system includes a WiMAX system, and the QoS control entity is provided on a BS or an ASN GW.

Further, a visit network acquires user subscription information including the priority parameter information of the user from a home network of the user, and provides the corresponding QoS guarantee for the user. Because the invention provides corresponding priority parameter information for each user respectively in the wireless communication system, and provides differentiated services for each user according to the priority parameter information, the invention can embody provision of the differentiated services for the different users in a wideband wireless access system of WiMAX or the like so as to enable an Network Operator to provide abundant operating service modes.

### BRIEF DESCRIPTIONS OF THE DRAWINGS

FIG. 1 is an exemplary flowchart of processing according to the method of the invention;

FIG. 2 is a flowchart of acquiring user priority parameter information in an embodiment of the invention;

FIG. 3 is a flowchart of a method for acquiring priority parameter information in an embodiment of the invention;

FIG. 4 is a flowchart of another method for acquiring priority parameter information in an embodiment of the invention.

### DETAILED DESCRIPTIONS OF THE EMBODIMENTS

An essence of the invention lies in that priority parameter information is set respectively for users in a wireless communication system, and sent to a QoS control entity by authentication and authorization processes; and the QoS control entity makes a corresponding QoS control for a user service dependent upon user priority parameter information.

The invention is described in detail as follows by way of an example in which the invention is implemented in a WiMAX system in order to make the principle, features and advantages of the invention more apparent.

Currently, User Priority parameter has not been defined in the User Profile in a WiMAX system. The invention adds the User Priority in the User Profile to embody differentiated services for users. Also, this parameter may be passed in an AAA flow or other QoS entity negotiation flow (e.g., a policy function entity), and implemented by a QoS control entity in each WiMAX network entities (BS or other logical entities) to provide a corresponding QoS guarantee for a user service.

The QoS control entity is located in a Base Station (BS), and therefore it is definitely required that the user priority parameter information be passed to the BS. Also, the QoS control entity may be located in an ASN GW, and here it is required that the user priority parameter information be passed to the ASN GW.

According to the invention, the User Priority of a user level is defined in WiMAX to embody differentiated services for different user levels.

Various mechanisms, such as admission control and resource allocation, for a user service may be implemented inside the ASN of WiMAX according to the User Priority of a user level, and in particular, these mechanisms include the QoS control for various service flows of a user.

Embodiments of the method in the invention are described as follows with reference to the drawings.

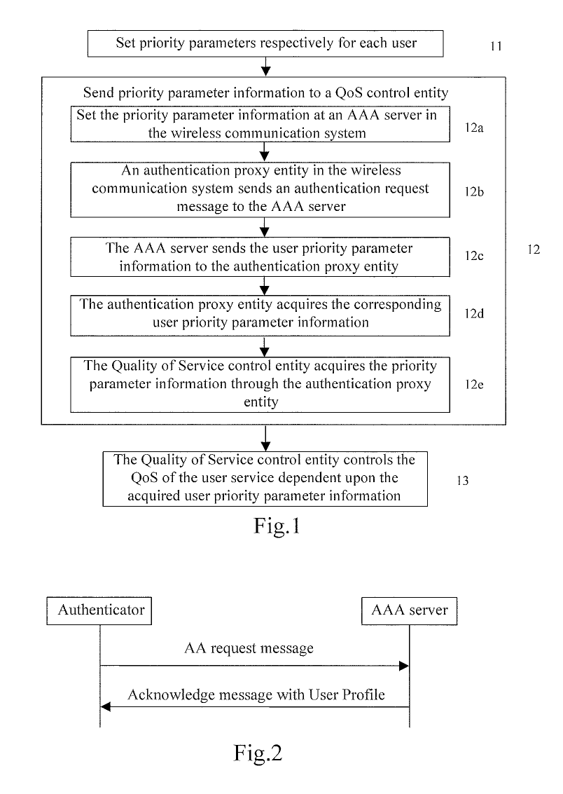

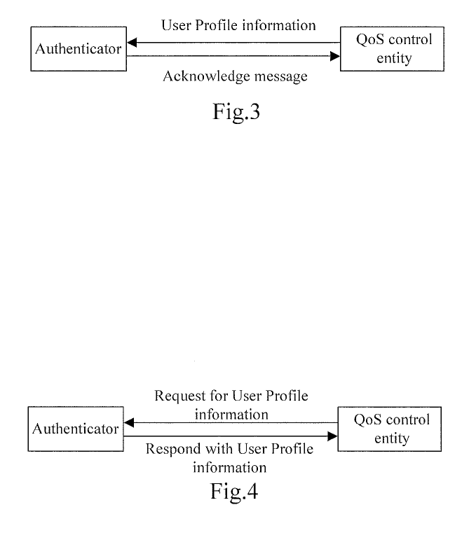

FIG. 1 is an exemplary flowchart of processing according to the method of the invention. Referring to FIG. 1, embodiments of the method in the invention are as illustrated in FIG. 2, FIG. 3 and FIG. 4, which illustrate primary steps of acquiring user priority parameter information, and in particular these steps include,

In Block 11, priority parameters are set respectively for each user.

The User Priority indicates a differentiated user level, which is intended to differentiate various users in the WiMAX system, and the QoS for an important user may be guaranteed preferentially. For example, QoS control logical entities including but not limited to admission control, resource allocation, congestion control, QoS implementing (scheduling, buffering, or the like) shall take the differentiated user level into account.

Specifically, the User Priority of a user level is defined in WiMAX to embody differentiated services for users with different levels.

According to the invention, this parameter may be represented by 8 bits and range from 0 to 127. Currently values 1, 2 and 3 are recommended, specifically, users may be categorized into three levels, i.e. Gold, Silver and General. Of course in a practical application, the parameter is not limited to the above specific definition, but the users may be categorized into more or less priority levels as required.

In Block 12, the user priority parameter information is transferred to the QoS control entity.

The QoS control entity is located in the BS and also possibly in the ASN GW, and therefore, it is required in this Block that the user priority parameter information be transferred to the BS or to the ASN GW.

In Block 13, the QoS control entity controls the QoS of a service for a user dependent upon the acquired user priority parameter information.

The QoS control particularly includes resource reservation, admission control, congestion control, and the like, for the service. In other words, the User Priority of a user level may be used in a plurality of QoS implementing mechanisms including ASN resource reservation, admission control, congestion control, and the like.

For instance, a resource is reserved for a Gold user, and disallowed to be used for any user of other levels.

For instance, different admission thresholds are set, and an access of only a high-level user is allowed when the system load of a certain level is reached.

For instance, data packets of a low-level user are first discarded upon congestion of system resources.

For various implementing mechanisms, the invention may further set flexibly the QoS implementing mechanisms as needed in practice.

It shall be noted that the User Priority parameter information of a user level effects on all service flows of the user. In other words, this parameter is applied to all services of the user.

The reason lies in that, because the User Priority parameter information is a differentiated service level for a user, if the user subscribes for a plurality of services to access, all implementing mechanisms inside the WiMAX ASN are uniformly mapped according to the User Priority of the user. For instance, if a user A is a Gold user, an interactive video service and a conversational service of the user will be at a Gold level, and the User Priority level will be mapped in the implementing mechanisms inside the WiMAX ASN for all subscribed services of the user.

In the above processing procedure, an essence thereof lies in how the QoS control entity acquires respective user priority parameter information, and a specific implementing procedure in which QoS control entity acquires the user priority parameter information is described below.

Referring to FIG. 1 again, particularly, acquisition of the user priority parameter information includes:

In Block 12a, the user priority parameter information is set at an AAA server in the wireless communication system, and the User Priority parameter may be at least defined as three levels, i.e. Gold, Silver and General.

In Block 12b, an authenticator in the wireless communication system sends to the AAA server an authentication request message for acquiring corresponding User Profile information.

As illustrated in FIG. 2, an authenticator requests the AAA server for authorization and authentication, i.e. an AA request message, in an AAA flow.

In Block 12c, the AAA server sends to the authenticator the user priority parameter information along with other User Profile information sent to the authenticator.

The AAA server returns the corresponding User Profile including the added User Priority parameter information, and thus upon acquisition of the User Profile from the authentication and authorization flow, the authenticator may pass the User Profile to a QoS control logical entity responsible for resource allocation or admission control or congestion control or other QoS control functions.

In Block 12d, the authenticator acquires the corresponding user priority parameter information.

In Block 12e, the QoS control entity, i.e. the QoS control logical entity acquires the user priority parameter information via the authenticator.

The QoS control logical entity represents an entity that controls implementation of a QoS user plane, and for instance includes a logical entity for resource allocation or admission control or congestion control.

In other words, the User priority parameter information is passed by the authentication and authentication flow, identified by the respective entities in the WiMAX network, and applied to different services, such as resource allocation, admission control and congestion control, for service flows of the user.

In Block 12e, the QoS control logical entity may acquire the user priority parameter information via the authenticator in two ways particularly as illustrated in FIG. 3 and FIG. 4, which will be described below respectively.

The first way to acquire the user priority parameter information is as illustrated in FIG. 3 and in particular as follows,

Upon acquisition of the User Profile from the authentication and authorization flow, the authenticator sends initiatively to the known QoS control logical function entity the User Profile information including the User Priority parameter information;

Upon acquisition of the User Profile information, the QoS control logical function entity returns an acknowledge message to the authenticator.

The second way to acquire the User Priority parameter information is as illustrated in FIG. 4 and in particular as follows,

Upon acquisition of the user profile from the authentication and authorization flow, the authenticator stores the user profile locally.

When discovering no User Profile information, the QoS control logical function entity sends to the authenticator a corresponding message requesting for the User Profile.

The authenticator returns to the QoS control logical function entity the User Profile including the user priority parameter information.

The above two ways for acquiring the user priority parameter information by the QoS control logical function entity may be used separately, or they may be combined to use.

Further in the method of the invention, for a roaming user, the QoS control logical function entity for the user of a visit network may acquire user priority parameter information in the same way, and in particular the visit network may acquire user subscription information including the user priority parameter information, i.e. the User Profile, from an AAA server of a Home Network.

The above AAA server may be replaced with a QoS Policy Function (PF) entity, and the above authenticator may be replaced with a QoS policy enforcement entity.

For a scenario across Operators, according to the method of the invention, QoS control may by implemented dependent upon a service agreement between the two parties, and the ASN of a visit network may be advised to embody similarly the differentiated services for a user. For instance, an Operator A and an Operator B sign a cooperation agreement in which the same differentiated treatment shall be followed for a user who roams from a network A to a network B (the network B may acquire from the network A the user subscription information including the user priority parameter information), and a Gold user shall be offered preferential resource reservation, admission control and congestion control. Specific details may be defined in a Service Level Agreement (SLA) dependent upon the implementing mechanisms of the networks of the both parties.

Conclusively, the invention may provide differentiated services for different users in a WiMAX system so as to satisfy the need of providing differentiated service modes in a wireless communication system.

The above descriptions are merely illustration of the preferred embodiments of the invention, but the scope of the invention shall not be limited to these. All variations or substitutions readily occurred to those skilled in the art without departing from the technical disclosure of the invention shall be encompassed within the scope of the invention. Accordingly, the scope of the invention shall be defined by the appended claims.

1. A method for guaranteeing Quality of Service (QoS) for a user in a wireless communication system, comprising:
setting priority parameter information for the user of the wireless communication system;
acquiring, by a QoS control entity, the priority parameter information of the user; and
providing a corresponding QoS guarantee for the user dependent upon the priority parameter information of the user.

2. The method according to claim 1, wherein the priority parameter information of the user is set at an Authorization, Authentication and Accounting server (AAA) server or a QoS policy function entity of the wireless communication system.

3. The method according to claim 1, wherein the acquiring of the priority parameter information of the user comprises:
acquiring, by the QoS control entity, the priority parameter information of the user from an authenticator or a QoS policy enforcement entity.

4. The method according to claim 3, wherein:
when requiring user subscription information, the QoS control entity sends initiatively a request to the authenticator or the QoS policy enforcement entity, and acquires the priority parameter information of the user; or
the authenticator or the QoS policy enforcement entity sends initiatively the priority parameter information of the user to the QoS control entity upon acquisition of the priority parameter information of the user.

5. The method according to claim 4, wherein the authenticator or the QoS policy enforcement entity sends requests to an AAA server or a QoS policy function entity for QoS parameters before the priority parameter information of the user is acquired from the authenticator or the QoS policy enforcement entity; and
the AAA server or the QoS policy function entity returns User Profile information including the priority parameter information of the user to the authenticator or the QoS policy enforcement entity.

6. The method according to claim 4, further comprising:
storing, by the authenticator or the QoS policy enforcement entity, the acquired priority parameter information of the user locally; and
sending, by the authenticator or the QoS policy enforcement entity, the priority parameter information of the user to the QoS control entity when a request for acquiring the User Profile is sent from the QoS control entity to the authenticator or the QoS policy enforcement entity.

7. The method according to claim 4, wherein the authenticator or the QoS policy enforcement entity sends the priority parameter information of the user to the QoS control entity upon acquisition of the priority parameter information of the user.

8. The method according to claim 1, further comprising:
implementing resource allocation, admission control, congestion control or other QoS mechanisms for a user service dependent upon the priority parameter information of the user.

9. The method according to claim 1, wherein the wireless communication system comprises a World Interoperability for Microwave Access system, and the QoS control entity is disposed on a Base Station or an Access Serving Network Gateway.

10. The method according to claim 1, further comprising:
acquiring, by a visit network, user subscription information including the priority parameter information of the user from a home network of the user, and providing the corresponding QoS guarantee for the user.
